(19) United States
(12) Patent Application Publication
(10) Pub. No.: US 2017/0006066 A1
(43) Pub. Date: Jan. 5, 2017

(54) ELECTRONIC SECURITY CONTAINER

(71) Applicant: MorphoTrust USA, LLC, Billerica, MA (US)

(72) Inventor: Robert Andrew Eckel, Andover, MA (US)

(21) Appl. No.: 15/197,933

(22) Filed: Jun. 30, 2016

Related U.S. Application Data
(60) Provisional application No. 62/186,726, filed on Jun. 30, 2015.

(51) Int. Cl. H04L 29/06; G06F 21/10

(52) U.S. Cl. CPC H04L 63/20; H04L 63/10; H04L 63/08; G06F 21/10

(57) ABSTRACT

One aspect of the invention features an ESC. The ESC includes a user-defined set of authentication credentials including at least one credential that is unique to a user, where the set of authentication credentials define a security level of the ESC for granting access to content stored in the ESC. An authorization policy defining authentication requirements for at least one requestor. And, a security mapping policy that translates requestor authentication credentials, from the at least one requestor, to a security strength for comparison to a security strength of the security level of the ESC.

### CROSS-REFERENCE TO RELATED APPLICATION

This application claims the benefit of the filing date of U.S. Provisional Application No. 62/186,726, filed on Jun. 30, 2015. The contents of U.S. Application No. 62/186,726 are incorporated herein by reference in their entirety.

### TECHNICAL FIELD

This specification relates to electronic data security.

### BACKGROUND

Electronic data security and privacy is increasingly important in modern communication and computer systems. Private personal and private corporate information is increasingly stored in electronic formats including, for example, electronic forms of identification, electronic payment methods, electronic healthcare records, and electronic legal and business documents. Techniques for securing electronic data include encryption credential based access to data storage systems.

### SUMMARY

This specification relates to an electronic security container (ESC) and methods and systems for accessing user content contained in an ESC.

One aspect of the invention features an ESC. The ESC includes a user-defined set of authentication credentials including at least one credential that is unique to a user, where the set of authentication credentials define a security level of the ESC for granting access to content stored in the ESC. An authorization policy defining authentication requirements for at least one requestor. And, a security mapping policy that translates requestor authentication credentials, from the at least one requestor, to a security strength for comparison to a security strength of the security level of the ESC.

This and other implementations can each optionally include one or more of the following features. The security level can be a first security level and the user-defined set of authentication credentials can be a first set of user-defined set of authentication credentials. In addition, the ESC can include a second user-defined set of authentication credentials including at least one credential that is unique to a user, where the second set of authentication credentials define a second security level of the ESC for granting access to content stored in the ESC. A security strength of the second security level can be greater than the security strength of the first security level.

Another aspect of the invention features an ESC electronic device. The electronic device includes a user-defined set of authentication credentials including at least one credential that is unique to a user, where the set of authentication credentials define a security level of the ESC for granting access to content stored in the ESC. An authorization policy defining authentication requirements for at least one requestor. And, a security mapping policy that translates requestor authentication credentials, from the at least one requestor, into a security strength for comparison to a security strength of the security level of the ESC.

This and other implementations can each optionally include one or more of the following features. The electronic device can be a cloud server. The electronic device can be a mobile computing device. The electronic device can be a microchip on a chip-card.

Other aspects of the subject matter described in this specification can be embodied in methods that include actions of receiving a request to access content contained in an ESC from a requestor. Obtaining user consent for the requestor to access data contained in the ESC. Determining whether the request is authentic based on authentication credentials of the requestor in response to obtaining the user consent. Determining whether a security strength of the requestor's authentication credentials meets or exceeds a security strength that is associated with a security level of the ESC, where the security level of the ESC is defined by a user-defined set of authentication credentials including at least one credential that is unique to a user. Providing the requestor access to content contained in the security level of the ESC in response to determining that the security strength of the requestor's authentication credentials meet or exceed the security strength of the security level of the ESC.

This and other implementations can each optionally include one or more of the following features. Obtaining user consent for the requestor to access data contained in the ESC can include verifying that the user has authorized the requestor to access data contained in the ESC based on authorization policies of the ESC. Obtaining user consent for the requestor to access data contained in the ESC can include requesting authorization for the requestor to access content from the ESC from the user, and receiving a user input indicating authorization for the requestor to access content from the ESC. The user input may indicate one or more security levels of the ESC from which the requestor can access content.

Determining whether a security strength of the requestor's authentication credentials meets or exceeds a security strength that is associated with a security level of the ESC can include determining the security strength of the requestor's authentication credentials based on a security mapping policy of the ESC, determining the security strength that is associated with the user-defined set of authentication credentials that define the security level of the ESC, and comparing the security strength of the requestor's authentication credentials to the security strength of the user-defined set of authentication credentials.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B depict a representations of example electronic security containers according to implementations of the present disclosure.

FIG. 2 depicts an example system that can execute implementations of the present disclosure.

FIGS. 3 and 4 depict example processes that can be executed in accordance with implementations of the present disclosure.

Like reference numbers and designations in the various drawings indicate like elements.

### DETAILED DESCRIPTION

Implementations of the present disclosure generally relate to an ESC, and methods and systems for accessing user content (e.g., user data) contained in an ESC. More particularly, an ESC is a secure data structure that prevents access to other content, for example, non-encrypted user data, unless the accessing entity is properly authenticated. For example, the ESC serves as an electronic safe for storing non-encrypted data (e.g., ESC contents data) which is only accessible upon proper authentication of an accessing entity (e.g., another (non-owner) user, a business, a government agency). Thus, the ESC differs from present data security techniques in o that instead of encrypting sensitive data itself, the sensitive data can be stored in its plain (unencrypted) format (e.g., as plain text file, a jpg image file) “inside” a secure electronic container; the ESC. In addition, the ESC is unique to each owner/user because access policies and credentials are completely user defined and require the use of at least one attribute that is unique to the owner. That is, the owner/user defines both number and type of credentials required to access data stored in the ESC. The ESC is defined by and based on credentials associated with an owner/user (e.g., a user who owns the ESC), except where further clarification may be required such as in reference to a non-owner user. For simplicity, however, the term user is used throughout the remainder of the description in reference to an owner/user, except where further clarification may be required.

The ESC can be implemented on a physical ESC card (e.g., as a microchip on a standard identity document card), on a computing device (e.g., as an app on smartphone), or on a hosted computing environment (e.g. a cloud-hosted service). Access to the ESC can be authenticated using any user defined combination of authentication credentials such as, but not limited to, authentication images (e.g., digital watermarks, quick recognition (QR) codes), near field communication (NFC) codes, radio frequency identification (RFID) codes, biometrics, or other appropriate authentication credentials. Authentication credentials may, but need not, include any personally identifiable information (PII).

For example, instead of carrying identity documents (e.g., a driver's license or passport) a user may store electronic identity documents in an ESC and simply carry the ESC. When an accessing entity (e.g., another (non-owner) user, business, government agency) requests the user's identity documents, the user may simply present their ESC. For example, at a customs checkpoint the user may place their smartphone near a customs computer. The user's smartphone can receive the customs agency's authentication credentials for accessing the user's ESC from the customs computer, for example, via NFC. Upon authentication of the customs agency's authentication credentials and according to the policy set in the ESC by the user, the user's smartphone can provide the customs computer with access to the user's electronic passport stored in the ESC. For example, a policy can include a set of rules (e.g., one or more conditions or combinations of conditions or) or procedures for authorizing a user to access the ESC or data stored in the ESC.

As another example, the ESC can contain a user's credit card information, and the user can provide a business (e.g., a supermarket) with access to the ESC. For example, when the user checks out at the supermarket the user can present a smartphone (with the digital container). The smartphone can receive the supermarket's authentication credentials from a point of sale (POS) computer, verify the supermarket's authentication credentials according to the policy set in the ESC by the user, and, in response, provide the supermarket's POS computer with the access to the user's credit card information.

In some examples, the ESC itself may be stored on a server and a user's ESC card or ESC application can include identification data (e.g., a coded image, NFC code, or RFID code) that identifies the user's ESC. The accessing entity can access the user's ESC identification data, and transmit the ESC identification data along with the accessing entity's credentials for accessing the contents of the user's ESC to the server that hosts the user's ESC. After authenticating the accessing entity, the server can provide the accessing entity with access to the contents of the user's ESC.

The ESC can have several levels of access (e.g., multiple “inner safes”), each access level having more stringent authentication requirements, for example, for storing more sensitive data or to allow a user to segregate data as available to some entities but not to others. For example, entity A (e.g., a DMV) may be permitted to access the data stored within the first access level (e.g., electronic driver's license), but not data stored within a second access level. Entity B (e.g., a business) may be able to access data stored within the first and second access levels, for example, an electronic driver's license in the first level and credit card information in the second level.

The ESC has two access methods (e.g., two sides of the “safe”), one for the user (e.g., owner of the ESC) and one for an accessing entity. For example, because the user must have access to all security levels of the ESC any compromise of the user's access credentials would jeopardize the security of the data stored in all levels of the ESC. Therefore, a user access method may limit the user to performing only certain functions, for example, a user may only be permitted to add contents and destroy (e.g., remove without viewing) contents from the ESC. Thus, if a user's credentials are compromised the thief cannot actually view the contents of the ESC, but at most can only add new data or destroy existing data. On the other hand, accessing entities may be permitted to access data stored within the accessing entity's authorized level of the ESC, but may not be permitted to add or remove data.

In some examples, the content stored in the ESC can be automatically destroyed if someone without proper authorization attempts to access the content, for example, an attempted hack.

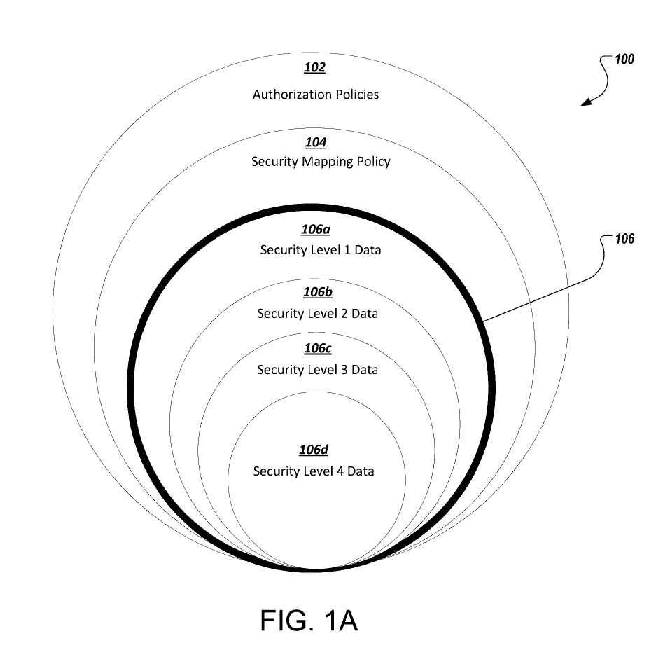

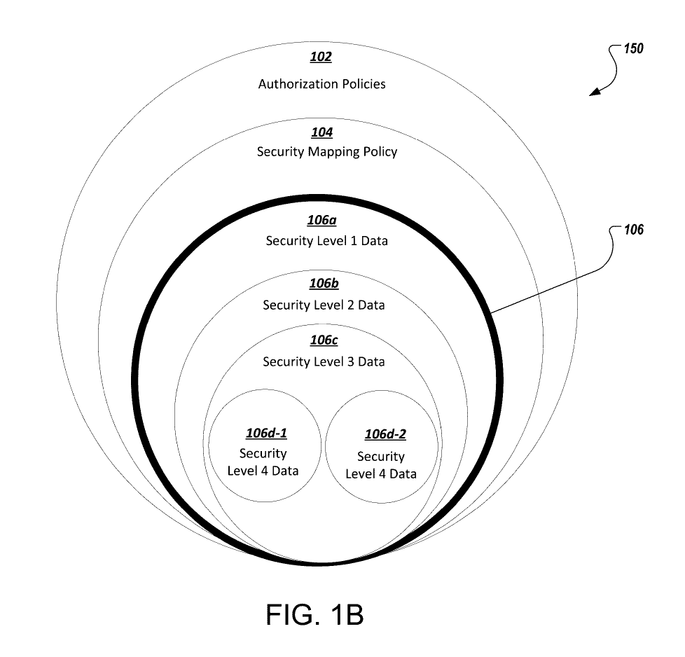

FIG. 1A depicts a representation of an example electronic security container 100 according to implementations of the present disclosure. The ESC 100 is a secure data structure that prevents access to user content and is defined by a user-defined set of authentication credentials. The set of authentication credentials define one or more security levels 106 that must be met in order to grant access to content stored in the ESC 100. Each of security levels 1-4 (106a-106d) may be defined by different, and increasingly more stringent, authentication credentials, and therefore a user may store more sensitive content in higher security levels of the ESC 100.

The user defined set of authentication credentials can include, for example, credentials such as fingerprints, facial recognition, retina or iris recognition, voice recognition (e.g., a voice print or voice password), social security number, passwords, digital watermarks, PIN numbers, NFC codes, QR codes, handwriting, movement based credentials (e.g., movement patterns, muscular/skeletal biometrics), or any other appropriate type of security or biometric credentials. Because the owner (user) defines which authentication credentials will form their particular ESC 100, and preferably at least one of the authentication credentials is unique to the owner (e.g., a biometric identifier), the ESC 100 itself will be unique to each a particular user. In some examples, the user defines a different set of authentication credentials to represent each security level (e.g., levels 106a-106b) of the user's ESC 100. That is, in order for a user to gain access to content stored in the ESC 100, to add content to the ESC, or to modify attributes of the ESC (e.g., policies, security levels, or authentication credentials) the user must provide each of the authentication credentials included in user defined set of credentials for the particular security level.

Thus, simply knowing which types of authentication credentials are required for a given security level is itself an authorization credential. That is, each user may require different numbers and/or types of authentication credentials to access their ESC 100, or various security levels of their ESC 100. In some implementations, even the order in which each credential in a set of authorization credentials is presented can itself form a type of authentication credential (e.g., a password made up of security credentials). In some examples, the ESC 100 can encrypt content contained in the ESC 100 by using the user's authentication credentials in the user-defined set of authentication credentials to as an encryption key to encrypt the content. For example, a first user may define an ESC 100 using their fingerprint, a password, and their voiceprint, in no particular order. Whereas, a second user may define an ESC 100 using their social security number, password, facial recognition data, and iris recognition data, in that specific order. Therefore, the first and second user's respective ESC's are not only unique to each user based on their respective credentials (biometric and otherwise), but also based on the number, type, and order of the authentication credentials used to define each user's ESC 100.

In some implementations, the ESC 100 may even develop with the user, for example, as the user ages. For example, biometric authentication credentials chosen by the user to define an ESC 100 may be periodically or continually updated as the user ages or changes. That is, for example, the user's facial appearance will change as the user ages, and therefore, a corresponding authentication credential and, by extension, the ESC 100 will change over time. Thus, the ESC 100 can, in a sense, be considered a shadow of the user himself.

In addition, the ESC 100 includes a set of authorization policies 102 and a security mapping policy 104. The authorization policies 102 and security mapping policy 104 allow a requestor (e.g., another (non-owner) user, a business, a government agency) to access content from a user's ESC 100. The authorization policies 102 allow a user to delineate which requestors are permitted to access content from the user's ESC 100. For example, the authorization polices 102 can include a sets of rules or procedures for allowing a user to access an ESC or data contained in an ESC. For example, authorization policies 102 can include a user-defined access control list (ACL) identifying requestors that are permitted to access content from the user's ESC 100. In addition, the authorization policies 102 may include data identifying which security levels 106 of the ESC 100 that each requestor is permitted to access.

While a user may be able to access content stored in their ESC 100, or provide access to a requestor by presenting the correct combination of the user's own authentication credentials, in some implementations, a user may authorize a requestor to access and ESC 100 based on the requestor's own authentication credential(s). In such implementations, the security mapping policy 104 provides a means for evaluating a requestor's authentication credentials compared to the user-defined set of authentication credentials that define the ESC 100 or a particular security level 106 of the ESC 100. For example, the security mapping policy 104 can include a set of rules or procedures for evaluating a requestor's authentication credentials compared to the user-defined set of authentication credentials that define the ESC 100 or a particular security level 106 of the ESC 100. More specifically, the security mapping policy 104 compares an objective security strength of the authentication credentials provided by the requestor to an objective security strength of the user's set of authentication credentials used to define the ESC 100, or a particular security level 106 of the ESC 100 which the requestor is attempting to access. In some examples, the security mapping policy 104 includes algorithms for evaluating the security strength of authentication credentials and combinations of security credentials.

The owner of an ESC need not be an individual. In some implementations, an owner of an ESC can be an entity (e.g., a group of people such as a family, a business, an organization, a government entity, etc.). In such implementations, the ESC can be defined using a combination of authentication credentials from multiple members of the entity and/or credentials directly associated with the entity. For example, an ESC owned by a business can be defined by a set of authentication credentials including the CEO's fingerprint, the CFO's finger print and voice password, and an electronic access card for the business. Thus, in order to add content to the ESC or modify content contained in the ESC, both the CEO and CFO must provide their respective credentials.

FIG. 1B depicts another representation of an example electronic security container 150 according to implementations of the present disclosure. The ESC 150 illustrates a variation of ESC 100 shown in FIG. 1A. ESC 150 includes two separate security level 4 data containers 106d-1 and 106d-2. For example, in some implementations a user can use different sets of authentication credentials to define multiple data containers at the same (or similar) security level. That is, for example, both data containers 106d-1 and 106d-2 are defined using two different sets of user credentials that each have a similar security strength. For example, a user may wish to set a similar security level for storing both the user's driver's license and a particular credit card information, but may not want the same requestors to have access to both the credit card informant and the driver's license. Thus, a user can define both data containers 106d-1 and 106d-2 with the same set credentials (e.g., a PIN and a thumbprint in that particular order) therefore they will both have the same security strength, but may define an authorization policy (e.g., a set of rules or procedures) for each of the security level 4 data containers 106d-1 and 106d-2 that limits access only to authorized requestors. For example, the user can indicate that Business A can access data stored in data container 106d-1 (e.g., credit card information), that the DMV can access data stored in data container 106d-2 (e.g., driver's license), and that another user (e.g., a spouse) can access data stored in both data containers 106d-1 and 106d-2.

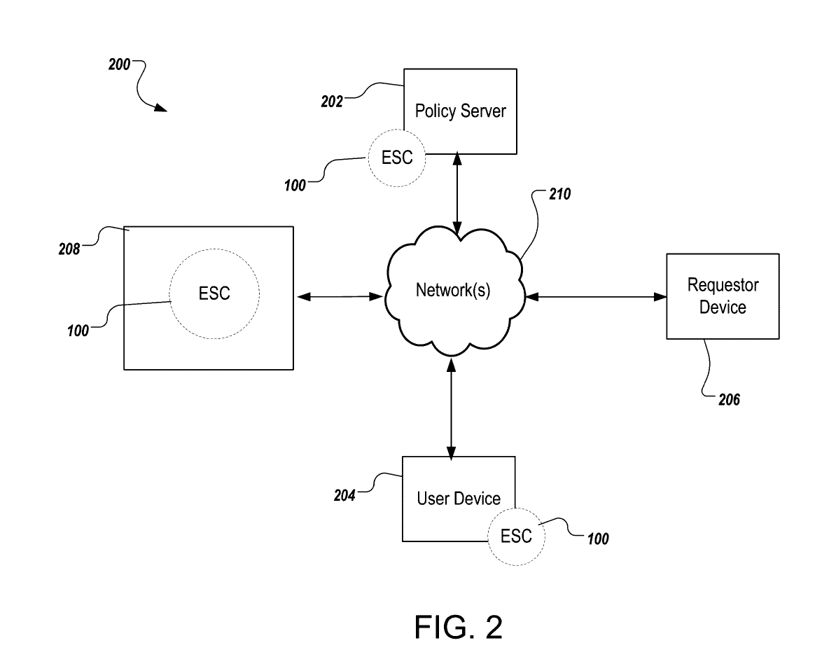

FIG. 2 depicts an example system 200 that can execute implementations of the present disclosure. The system 200 can be used to generate, maintain, and access content in an ESC 100. The system 200 includes a policy server 202, a user device 204, a requestor device 206, and, in some implementations, an ESC reader device 208. Each of the policy server 202, a user device 204, a requestor device 206, and ESC reader device 208 are in communication through one or more networks 210.

The policy server 202 can be one or more computing devices (e.g., servers) configured to generate, manage, or store one or more ESCs 100. The policy server 202 may have internal or external storage components storing data and programs such as an operating system and one or more application programs. For example, the policy server 202 can represent various forms of server systems including, but not limited to a web server, an application server, a proxy server, a network server, or a server farm. The one or more application programs can be implemented as instructions that are stored in the storage components and that, when executed, cause the one or more computing devices to generate an ESC 100 according to user defined parameters and evaluate user or requestor authentication credentials for providing access to content stored in an ESC 100. Furthermore, the policy server 202 can be a cloud server and can store ESCs 100 and their associated content.

The user device 204 and requestor device 206 can be computing devices including, for example, a mobile computing device (e.g., mobile phone, smartphone, personal digital assistant, tablet computer) a laptop, netbook computers, and desktop computers including personal computers, special purpose computers, general purpose computers, and/or combinations of special purpose and general purpose computers. Each of the computing devices 204 and 206 typically may have internal or external storage components for storing data and programs such as an operating system and one or more application programs. In some examples, the requestor device 206 can be a POS computing device. The user device 204 and requestor device 206 can include various input devices capable of receiving authentication credentials such as, for example, a keypad, keyboard, fingerprint scanner, camera, microphone, touch screen, and accelerometers.

The ESC reader device 208 may be an electronic device capable of reading an ESC 100 contained on an ESC card. For example, the ESC reader device 208 can be a card reader in communication with another computing device, for example, user device 204 or requestor device 206.

Network 210 may provide direct or indirect communication links between policy server 202, a user device 204, a requestor device 206, and ESC reader device 208. Examples of network 210 include the Internet, the World Wide Web, wide area networks (WANs), local area networks (LANs) including wireless LANs (WLANs), analog or digital wired and wireless telephone networks, wireless data networks (e.g., 3G and 4G networks), cable, satellite, and/or any other delivery mechanisms for carrying data.

The ESC 100 can be implemented on a physical ESC card (e.g., as a microchip on a Smart-chip card), on a user device 204 (e.g., as an app on smartphone), or on the policy server 202 (e.g. a cloud-hosted service). In some implementations, the ESC and its associated content are not stored at the policy server 202. For example, the ESC 100 and its associated content can be stored on a physical ESC card (e.g., as a chip on a standard identity document card) or on a user device 204. In such implementations, the policy server 202 can be used for generating ESCs 100 and to manage access to ESCs 100. For example, the policy server 202 can evaluate user and requestor authorization credentials. In some examples, the policy server 202 can maintain and enforce the authorization policies 102 and the security mapping policy 104.

In some implementations, the ESC 100 can be implemented as an application on user device 204. For example, a user may have an ESC application on their user device 204 (e.g., smartphone). The user may define their ESC (or one security level of their ESC) using a PIN number and their fingerprint. In some examples, the PIN number and fingerprint may represent a first security level of a user's ESC 100 because it is only using two types of authentication credentials. The user may store, for example, credit card payment information in this first level of security for their ESC 100, then use the first level of security to provide businesses access to payment information for routine purchases. In addition, a user can use one of two methods to provide a requestor (e.g., a business) with access to content stored in their ESC 100. One method is for the user to provide their authentication credentials to the ESC application, access the desired content (e.g., a credit card) themselves, and provide the content to the requestor (e.g., via a wireless link to a corresponding application on a POS system). The second method is for the user to grant specific requestors the ability to directly access content from the user's ESC 100. For example, upon authentication of the requestor using the requestor's own authentication credentials, the desired content can be transferred to the requestor's computing system (e.g., a POS system).

For example, a user may visit a coffee shop and wish to pay for their purchase using payment information (e.g., credit card information) stored in their ESC 100. The user may open their ESC 100 application on their smart phone and establish communications between a user device 204 and the requestor device 206 (e.g., a POS computer at the coffee shop). For example, the user device 204 may establish communications with the requestor device 206 through NFC. If the coffee shop POS computer has a corresponding ESC application and appropriate input devices to support receiving the user's authentication credentials, the user can provide the appropriate authentication credentials (e.g., PIN number and fingerprint) to access their ESC 100, and the payment information can be transferred from the ESC 100 on the user device 204 to the requestor device 206. For example, upon establishing communications, the POS computer may prompt a clerk to ask the user to present their authentication credentials. The user may then enter their PIN number on a keypad attached to the requestor device 206 and provide their fingerprint to a fingerprint reader attached to the requestor device 206. A third method is a dual authentication method in which both the users and the requestor's authentication credentials are required to grant the requestor access to content stored in the ESC.

In another example, the user may open an ESC application on the user's user device 204 and establish communications between the user device 204 and the requestor device 206. However, in this example the user may have granted the coffee shop authorization to access their ESC 100 (or at least content in one security level of their ESC 100) directly. For example, instead of the user providing their own authentication credentials to access the payment information from the ESC 100, the requestor device 206 can send an access request to the user device 204. The user device 204 receives the access request and verifies with the authorization policies 102 that the user has authorized the coffee shop to access the user's ESC 100. In some examples, the access request may be sent to the policy server 202 for verification based on the authorization policies 102. In addition, the access request may include authentication credentials for the requestor (e.g., the coffee shop). The user device 204 may send the requestor's authentication credentials to the policy server 202 for authentication.

In addition to verifying the authenticity of the coffee shops credentials, the policy server 202 may calculate a security strength for the coffee shop's authentication credentials. The policy server 202 can compare the security strength of the coffee shop's authentication credentials to the security strength of the user's authentication credentials for their ESC 100 (or the security level 106 of the ESC 100 to which the requestor requesting access). In this example, the policy server 202 would compare the security strength of the coffee shop's authentication credentials to the security strength of the user's combined fingerprint and PIN number. If the coffee shop's authentication credentials do not have a security strength that is at least equivalent to that of the user's combination of authentication credentials, the policy server 202 will deny access to the user's ESC 100, thereby ensuring that the requestor's credentials meet the user's minimum level of security for accessing the ESC 100 (or the specific security level 106 of the ESC 100). As long as security level of the coffee shop's authentication credentials meets or exceeds the security level of the user's authentication credentials, the policy server 202 will grant the requestor device 206 access to the user's payment information from the ESC 100.

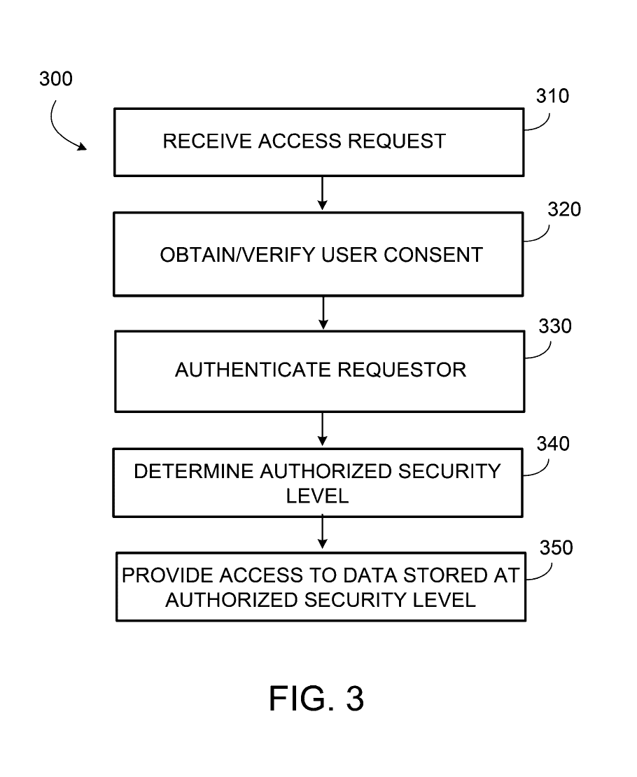

FIG. 3 depicts an example process 300 that can be executed in accordance with implementations of the present disclosure. In some examples, the example process 300 can be provided as one or more computer-executable programs executed using one or more computing devices. In some examples, the process 300 is executed provide access to content stored in an ESC.

A request to access content contained in an ESC is received from a requestor (310). User consent for the requestor to access data contained in the ESC is obtained (320). For example, authorization policies of the ESC may indicate that the user has authorized requestor to access data contained in an ESC. An identity of the requestor can be compared to data contained in the authorization policies of the ESC, for example, an access control list. If the user has not yet granted their consent authorizing the requestor to access content from the ESC, as indicated by the authorization policies, a request to grant authorization to the requestor may be sent to the user of the ESC.

The request is authenticated based on authentication credentials for the requestor (330). For example, the request may include authentication credentials for the requestor. The requestor's authentication credentials may be authenticated by, for example, an authentication server. An authorized security level which the requestor is permitted to access is determined (340). For example, it may be determined whether a security strength of the requestor's authentication credentials meets or exceeds a security strength required for access to a security level of the ESC. The security strength of the security level of the ESC may be determined based on a security strength of a user-defined set of authentication credentials that define the security level of the ESC. In response to determining that the security strength of the requestor's authentication credentials meet or exceed the security strength required to access the ESC, the requestor is provided access to content contained in the ESC (350).

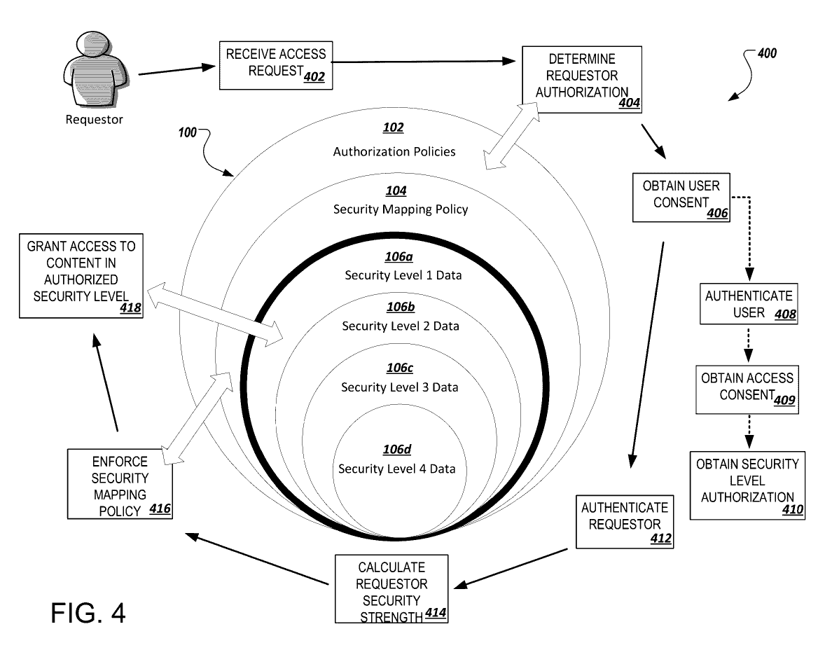

FIG. 4 depicts an example process 400 that can be executed in accordance with implementations of the present disclosure. In some examples, the example process 400 can be provided as one or more computer-executable programs executed using one or more computing devices. In some examples, the process 400 illustrates a more detailed example of process 300 for providing access to content stored in an ESC 100.

A request to access content contained in an ESC 100 is received from a requestor (402). The requestor's authorization to access one or more security levels 106a-106d of the ESC 100 is determined from the authorization policies 102 (404). The authorization policies 102 may indicate whether or not the user has granted consent for the requestor to access the ESC 100 (406). In some examples, the authorization policies 102 may also indicate which security levels 106 of the ESC that the requestor is authorized to access. If the authorization policies 102 indicate that user has not yet authorized the requestor to access content from the ESC 100, a request to grant authorization to the requestor may be sent to the user of the ESC 100. Upon receiving the request to authorize a requestor, the ESC 100 user may be required to provide the user's authentication credentials (408). The user is authenticated based on the user's authentication credentials. After being authenticated, the user may grant authorization for the requestor to access content from the ESC 100 (409). In addition, the user may indicate one or more of the security levels 106a-106d of the ESC 100 from which the requestor will be authorized to access content (410).

The identity of the requestor is authenticated (412). For example, the access request may include authentication credentials for the requestor. The requestor's authentication credentials may be authenticated, for example, by an authentication server. The security level strength is calculated for the requestor's authentication credentials (414). For example, security credential strength algorithms may be included in the security mapping policy 104 of the ESC 100. The security strength of the requestor's authentication credentials may be calculated based on the security mapping policy algorithms. The security mapping policy 104 may ensure that the requestor's authentication credentials meet a minimum security strength to access the various security levels of the ESC 100. For example, the security strength required to access each security level of the ESC 100 may be determined based on the security strength of the respective user-defined sets of authentication credentials used to define each respective security level of the ESC 100. The security strength of each ESC 100 security level may be stored as part of the security mapping policy 104 the security mapping policy are enforced by, for example, comparing the security strength of the requestor's authentication credentials to the security strength of the ESC 100 security level to which the requestor is seeking access (416).

In response to determining that the security strength of the requestor's authentication credentials meet or exceed the security strength required to access the appropriate security level of the ESC 100, the requestor is provided access to content contained in that security level of the ESC 100 (418).

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer, storage medium is not a propagated signal; a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data o include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component (e.g., such as a data server), or that includes a middleware component (e.g., an application server), or that includes a front-end component (e.g., a client computer having a graphical user interface or a Web browser through which a user can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An electronic security container (ESC) comprising;
an electronic device containing:
a user-defined set of authentication credentials including at least one credential that is unique to a user, the set of authentication credentials defining a security level of the ESC for providing access to content stored in the ESC;
an authorization policy defining authentication requirements for at least one requestor; and
a security mapping policy that translates requestor authentication credentials, from the at least one requestor, to the a security strength for comparison to a security strength of the security level of the ESC.

2. The ESC of claim 1, wherein the security level is a first security level and the user-defined set of authentication credentials is a first set of user-defined set of authentication credentials, and the ESC further comprises:
a second user-defined set of authentication credentials including at least one credential that is unique to a user, the second set of authentication credentials defining a second security level of the ESC for granting access to content stored in the ESC.

3. The ESC of claim 2, where a security strength of the second security level is greater than the security strength of the first security level.

4. The ESC of claim 1, wherein the electronic device is a cloud server.

5. The ESC of claim 1, wherein the electronic device is a mobile computing device.

6. The ESC of claim 1, wherein the electronic device is a microchip on a chip-card.

7. The ESC of claim 1, wherein the set of authentication credentials include an ordered set of two or more authentication credentials.

8. The ESC of claim 1, wherein the authentication requirements for the at least one requestor comprise data identifying one or more security levels of the ESC that the requestor is permitted to access.

9. The ESC of claim 1, wherein the security mapping policy includes a minimum security strength that the requestor's authentication credentials must meet to access o each of one or more security levels that the requestor is authorized to access.

10. The ESC of claim 1, wherein the authorization policy includes an access control list that identifies requestors that are permitted to access content from the ESC.

11. A computer-implemented method executed by one or more processors, the method comprising:
receiving, from a requestor, a request to access content contained in an electronic security container (ESC);
obtaining, by the one or more processors, user consent for the requestor to access data contained in the ESC;
in response to obtaining the user consent, determining, by the one or more processors, whether the request is authentic based on authentication credentials of the requestor;
determining, by the one or more processors, whether a security strength of the requestor's authentication credentials meets or exceeds a security strength that is associated with a security level of the ESC, the security level of the ESC being defined by a user-defined set of authentication credentials including at least one credential that is unique to a user;
in response to determining that the security strength of the requestor's authentication credentials meet or exceed the security strength of the security level of the ESC, providing the requestor access to content contained in the security level of the ESC.

12. The method of claim 11, wherein obtaining user consent for the requestor to access data contained in the ESC comprises verifying, based on authorization policies of the ESC, that the user has authorized the requestor to access data contained in the ESC.

13. The method of claim 11, wherein obtaining user consent for the requestor to access data contained in the ESC comprises:
requesting, from the user, authorization for the requestor to access content from the ESC; and
receiving a user input indicating authorization for the requestor to access content from the ESC.

14. The method of claim 13, wherein the user input indicates one or more security levels of the ESC from which the requestor can access content.

15. The method of claim 7, wherein determining whether a security strength of the requestor's authentication credentials meets or exceeds a security strength that is associated with a security level of the ESC comprises:
determining the security strength of the requestor's authentication credentials based on a security mapping policy of the ESC;
determining the security strength that is associated with the user-defined set of authentication credentials that define the security level of the ESC; and
comparing the security strength of the requestor's authentication credentials to the security strength of the user-defined set of authentication credentials.

16. A system comprising:
one or more processors; and a data store coupled to the one or more processors having instructions stored thereon which, when executed by the one or more processors, causes the one or more processors to perform operations comprising:
receiving, from a requestor, a request to access content contained in an electronic security container (ESC);
obtaining user consent for the requestor to access data contained in the ESC;
in response to obtaining the user consent, determining whether the request is authentic based on authentication credentials of the requestor;
determining whether a security strength of the requestor's authentication credentials meets or exceeds a security strength that is associated with a security level of the ESC, the security level of the ESC being defined by a user-defined set of authentication credentials including at least one credential that is unique to a user;
in response to determining that the security strength of the requestor's authentication credentials meet or exceed the security strength of the security level of the ESC, providing the requestor access to content contained in the security level of the ESC.

17. The system of claim 16, wherein obtaining user consent for the requestor to access data contained in the ESC comprises verifying, based on authorization policies of the ESC, that the user has authorized the requestor to access data contained in the ESC.

18. The system of claim 16, wherein obtaining user consent for the requestor to access data contained in the ESC comprises:
requesting, from the user, authorization for the requestor to access content from the ESC; and
receiving a user input indicating authorization for the requestor to access content from the ESC.

19. The system of claim 18, wherein the user input indicates one or more security levels of the ESC from which the requestor can access content.

20. The system of claim 16, wherein determining whether a security strength of the requestor's authentication credentials meets or exceeds a security strength that is associated with a security level of the ESC comprises:
determining the security strength of the requestor's authentication credentials based on a security mapping policy of the ESC;
determining the security strength that is associated with the user-defined set of authentication credentials that define the security level of the ESC; and
comparing the security strength of the requestor's authentication credentials to the security strength of the user-defined set of authentication credentials.
